(19) United States
(12) Patent Application Publication
(10) Pub. No.: US 2026/0133071 A1
(43) Pub. Date: May 14, 2026

(54) PHOTODIODE ARRAY SPECTROMETER CALIBRATION

(71) Applicant: Waters Technologies Corporation, Milford, MA (US)

(72) Inventors: Sean Eric Anderson, Westwood, MA (US); Sebastien Besner, Bolton, MA (US); James E, Usowicz, Webster, MA (US); Neal Pugh, Taunton, MA (US)

(21) Appl. No.: 19/388,080

(22) Filed: Nov. 13, 2025

Related U.S. Application Data
(60) Provisional application No. 63/719,939, filed on Nov. 13, 2024.

(51) Int. Cl. G01J 3/28; G01J 3/04; G01J 3/10

(52) U.S. Cl. CPC G01J 3/2803; G01J 3/04; G01J 3/10; G01J 2003/045; G01J 2003/2859; G01J 2003/2879

(57) ABSTRACT

Methods of photodiode array spectrometer calibration include acquiring a first spectrum using a first spectral source of a spectrometer; finding spectral data points at pixel locations from the first spectrum; replacing the first spectral source with a second spectral source in the spectrometer; finding spectral data points at pixel locations using the second spectral source; selecting one or more of the spectral data points; generating a calibration curve by fitting the selected spectral data points to one or more functions of the calibration curve; and using the selected spectral data points and the calibration curve to calibrate the spectrometer.

### RELATED APPLICATION

This application claims priority to U.S. Provisional Patent Application No. 63/719,939 filed on Nov. 13, 2024 and titled “Photodiode Array Spectrometer Calibration” the entirety of which is incorporated by reference herein.

### FIELD OF THE INVENTION

The disclosed technology generally relates to spectrometer calibration. More particularly, the technology relates to methods and systems for photodiode array spectrometer calibration.

### BACKGROUND

A photodiode array (PDA) spectrometer is an optical system used to measure the spectrum of a light source. A PDA spectrometer is particularly useful for measuring the absorbance of a sample as a function of wavelength across some spectral range. In an exemplary configuration, broad spectrum light is passed through a sample such as a cuvette or flow cell, and the light is subsequently redirected and diffracted onto a sensor array. The sample spectrum is compared to a reference spectrum to calculate the absorbance as a function of wavelength. The absorbance can be used for identification and quantitation of a sample, as well as for quality control purposes, for example in the pharmaceutical industry.

A photodiode array does not typically have any way of knowing what wavelength of light is hitting each pixel, it only provides a signal level as a function of pixel position. In order to convert the pixel position to an equivalent wavelength, calibration is required to account for the dispersion curve of the diffractive element (grating, prism etc). The dispersion curve describes how the spectrum is dispersed spatially and is a characteristic of the optical components of the system and their alignment.

Wavelength calibration is typically performed using either spectral calibration lamps or samples with well-characterized absorbance peaks or minima. The ‘known’ peaks/minima in either the spectrum or absorbance are identified in the photodiode array signal, and a curve is fit to identify wavelength as a function of pixel location. Common fits include polynomial fits such as linear, quadratic, cubic, or higher order fits, rational polynomial fits, as well as fits to the grating equation which models the physics of how a diffraction grating disperses light.

Wavelength calibration has several potential complications that can cause undesirable wavelength accuracy performance and undesired error. For example, the calibration typically requires calibration peaks to be well dispersed across the target wavelength range. Having insufficient peaks can cause errors in the fit, especially when the dispersion curve is nonlinear. It is also important to have peaks near the boundary of the target spectral range to minimize extrapolation errors. Extrapolation errors tend to be worse with higher-order fits which have more degrees of freedom to fit complex data, but are less stable beyond the calibration range.

Further, there can be discontinuities in the spectrum that can introduce error. For example, if there is an optical filter partially covering the sensor, as is the case with a typical order filter, light passing through the filter will refract slightly depending on its incident angle and the index of refraction of the filter as a function of wavelength. This refraction will cause an offset or shift in spectrum and can cause a discontinuity that introduces error.

Moreover, it may be inconvenient to require a spectral lamp or expensive standard for calibration in the field, it is desirable to maintain a robust and accurate calibration routine that can be maintained on-instrument.

Still further, even with a reasonable curve fit for calibration, the optical system may have a complex dispersion curve or aberration that can introduce systematic biases that are not easily corrected by fit. For example, moving to a higher-order fit may reduce the residuals/error within the calibration range, but can increase extrapolation error.

Calibration may also be made more difficult in cases of variable slit width. In cases where a spectrometer has a variable slit width, calibration may vary or shift with slit width, or may be more accurate at one slit width/resolution than another.

Therefore, improved devices and methods for photodiode array spectrometer calibration would be well received in the art.

### SUMMARY

In one aspect, a method of photodiode array spectrometer calibration includes acquiring a first spectrum using a first spectral source of a spectrometer. The method includes finding spectral data points at pixel locations from the first spectrum. The method includes replacing the first spectral source with a second spectral source in the spectrometer. The method includes finding spectral data points at pixel locations using the second spectral source. The method includes selecting one or more of the spectral data points. The method includes generating a calibration curve by fitting the selected spectral data points to one or more functions of the calibration curve. The method includes using the selected spectral data points and the calibration curve to calibrate the spectrometer.

Additionally or alternatively, the first spectral source is a Deuterium lamp and the second spectral source is a Mercury Argon lamp, and the first spectrum includes a Deuterium spectrum and an Erbium absorbance, and the second spectrum includes Mercury and Argon peak pixel locations.

Additionally or alternatively, the spectral data points are peak pixel locations, and using the selected one or more Mercury, Argon and Deuterium spectral data points and the calibration curve to calibrate the spectrometer further includes calculating an error in the Deuterium and Erbium peak pixel locations, including determining a residual value representing how far off the Deuterium and Erbium peak pixel locations are from the calibration curve. The method includes calculating a residual corrected wavelength using the residual values of the Deuterium and Erbium peak pixel locations. The method includes storing the calculated error, the residual value and/or the residual corrected wavelength into a calibration data storage system of the spectrometer.

Additionally or alternatively, the one or more functions includes a first function for a first pre-filter region and a second function for a post-filter region, the method further including describing the calibration curve as a piecewise function using the first function for the pre-filter region of a pixel range and the second function for the second function for the post-filter region of the pixel range.

Additionally or alternatively, the method further includes verifying the spectrometer calibration using the stored calculated error, the residual value and/or the residual corrected wavelength.

Additionally or alternatively, the method further includes using a plurality of gain and/or exposure settings to acquire peaks at different amplitudes over a range of the spectrums. The method includes generating the calibration curve by fitting the acquired peaks at different amplitudes over the range of spectrums to the one or more functions of the calibration curve.

Additionally or alternatively, the method further includes filtering data points of at least one of the first spectrum and the second spectrum for noise or to modify peak shape.

Additionally or alternatively, the method further includes replacing the second spectral source with the first spectral source in the spectrometer after the finding the peak pixel locations of the second spectral source.

Additionally or alternatively, the step of finding peak pixel locations using the second spectral source is conducted during manufacturing the spectrometer.

Additionally or alternatively, the steps of acquiring a Deuterium spectrum and Erbium absorbance using a Deuterium lamp of a spectrometer and finding Mercury and Argon peak pixel locations using the Mercury Argon lamp are each conducted in a controlled environment to minimize variation.

In another aspect, a method of photodiode array spectrometer calibration includes acquiring one or more spectrums using one or more spectral sources. The method includes generating a calibration curve for a spectrometer expressing wavelength over a pixel range of spectral data points for the one or more acquired spectrums. The method includes describing the calibration curve as a piecewise function using at least a first function over a first portion of the pixel range and a second function over a second portion of the pixel range. The method includes using the calibration curve for calibration of a spectrometer.

Additionally or alternatively, the first function is a first quadratic and the second function is a second quadratic.

Additionally or alternatively, the first function spans across a pre-filter region of the pixel range and the second function spans across a post-filter region of the pixel range.

Additionally or alternatively, the acquiring one or more spectrums using one or more spectral sources includes acquiring a first spectrum using a Deuterium lamp of the spectrometer and further includes acquiring a second spectrum from a Mercury Argon lamp.

Additionally or alternatively, the spectral data points include at least one of spectral peaks, spectral minima, absorbance peaks, absorbance minima, mean values, median values, inflection points and/or combinations thereof.

Additionally or alternatively, the spectral data points include at least one of peak maxima, peak minima, peak centroid, and/or combinations thereof.

Additionally or alternatively, the one or more spectral sources includes at least one lamp, laser, monochromator, LED, absorbance samples, and/or combinations thereof.

Additionally or alternatively, at least one of the first function and the second function are each selected from the group consisting of a polynomial function, a rational function, and a grating equation.

Additionally or alternatively, the at least one function includes three or more functions spanning across three or portion portions of the pixel range.

Additionally or alternatively, the method includes correcting for discontinuity due to a filter edge with the piecewise function.

In another aspect, a method of photodiode array spectrometer calibration includes acquiring one or more spectrums using one or more spectral sources. The method includes generating a calibration curve for a spectrometer by fitting a range of spectral data points to one or more functions of the calibration curve. The method includes generating a dispersion curve for the spectrometer. The method includes calculating an error in the generated calibration curve relative to the dispersion curve. The method includes storing the calculated error into a calibration data storage system of the spectrometer.

Additionally or alternatively, the calculating the error further includes determining a residual value representing how far off one or more of the range of spectral data points are from the generated calibration curve.

Additionally or alternatively, the calculating the error further includes at least one of analytically measuring the error across the one or more spectrums relative to the one or more functions and computationally calculating the error relative to the fit of the calibration curve.

Additionally or alternatively, the method further includes subtracting the calculated error from acquired data during a validation process to improve accuracy of the acquired data.

Additionally or alternatively, the first spectral source is a Deuterium lamp of the spectrometer, the method further including using the second spectral source to acquire the second spectrum, where the second spectral source is a Mercury Argon lamp.

Additionally or alternatively, the spectral data points include at least one of a spectral peak, a spectral minima, an absorbance peak, an absorbance minima, a mean value, a median value, an inflection point and/or combinations thereof.

Additionally or alternatively, the spectral data points include at least one of a peak maxima, a peak minima, a peak centroid, and/or combinations thereof.

Additionally or alternatively, the one or more spectral sources includes at least one lamp, laser, monochromator, LED, absorbance samples, and/or combinations thereof.

Additionally or alternatively, the method further includes calculating a residual corrected wavelength using the residual values for the first spectral data point.

Additionally or alternatively, spectral data points are interpolated using a method selected from the group consisting of a polynomial regression, a spline interpolation, a gaussian fit, and a first or second derivative method.

In another aspect, a method of photodiode array spectrometer calibration includes acquiring a first spectrum from a first spectral source of a spectrometer using a first slit position. The method includes performing a first calibration of the spectrometer using the first spectrum. The method includes acquiring a second spectrum from the first spectral source using a second slit position. The method includes performing a second calibration of the spectrometer using the second spectrum.

Additionally or alternatively, the method further includes determining whether the first calibration or the second calibration is more accurate. The method includes calibrating the spectrometer using the more accurate calibration.

Additionally or alternatively, the method further includes generating an average calibration using each of the first calibration and the second calibration. The method includes calibrating the spectrometer using the average calibration.

Additionally or alternatively, the method further includes acquiring a spectrum from the first spectral source of a spectrometer using each slit position of a variable slit device. The method includes performing a calibration of the spectrometer using the spectrum a from each slit position.

Additionally or alternatively, the method further includes determining which slit position of the variable slit device includes the most accurate calibration. The method includes calibrating the spectrometer using the most accurate slit position.

Additionally or alternatively, the method further includes generating an average calibration using each of calibrations from each slit position. The method includes calibrating the spectrometer using the average calibration.

In another aspect, a spectrometer is calibrated by any of the methods of photodiode array spectrometer calibration described above.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1A depicts a perspective view of a photodiode array (PDA) sensor being partially covered by an order filter, in accordance with one embodiment.

FIG. 1B depicts a graph plotting pixel offset as a function of wavelength for an exemplary PDA spectrometer, in accordance with one embodiment.

FIG. 2 depicts a top view of a PDA spectrometer, in accordance with one embodiment.

FIG. 3 depicts a schematic view of a PDA detector, in accordance with one embodiment.

FIG. 4A is a plot of the deuterium lamp spectrum and erbium filter absorbance spectrum vs pixel position. Spectral features such as peaks can be identified and used for spectrometer calibration, in accordance with one embodiment.

FIG. 4B depicts the peak wavelength vs pixel position, with a calibration curve fit, in accordance with one embodiment.

FIG. 5A depicts a graph plotting residual vs. wavelength and showing extrapolation error and UV error, in accordance with one embodiment.

FIG. 5B depicts a graph plotting residual vs. wavelength and showing extrapolation error and an order filter artefact, in accordance with one embodiment.

FIG. 6 depicts a graph showing an example Mercury spectrum showing main peaks from 253-546 nm, in accordance with one embodiment.

FIG. 7 depicts a graph showing a high exposure semi-log plot of a Mercury-Argon spectrum showing additional peaks that can be used in calibration, in accordance with one embodiment.

FIG. 8 depicts a graph showing an example piecewise calibration curve fitting two quadratics to mercury peaks, in accordance with one embodiment.

FIG. 9 depicts a graph showing simulated Mercury-Argon peaks for a Spectrometer in Zemax used to generate a computational calibration curve, in accordance with one embodiment.

FIG. 10A depicts a graph showing pre-correction empirical data with a Zemax correction function overlaid (black line) showing good alignment, in accordance with one embodiment.

FIG. 10B depicts a graph showing corrected data showing improved error across the spectrum, in accordance with one embodiment.

FIG. 11 depicts a front view of a variable slit mask having four slit widths, in accordance with one embodiment.

FIG. 12 depicts a graph showing a comparison of 313 nm Mercury spectral peaks when centered on or between two sensor pixels, in accordance with one embodiment.

FIG. 13 depicts a method of photodiode array spectrometer calibration using a Mercury/Argon lamp in addition to a Deuterium lamp and Erbium filter, in accordance with one embodiment.

FIG. 14 depicts a further method of calibrating the spectrometer using only a Deuterium lamp and Erbium filter using correction factors calculated during the calibration process in FIG. 13, in accordance with one embodiment.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, embodiments described herein provide for calibration methods and spectrometers having been calibrated using such methods. The methods and systems described herein are configured to address the issues described herein above with photodiode array spectrometer calibration. Aspects of the present disclosure provide for usage of polynomial fit of different orders or grating equation to perform calibration using a spectral calibration lamp or solid filter as a wavelength calibration standard and then using wavelength verification and/or validation using a second set of standards. Additionally, as contemplated herein, the dispersion curve or calibration curve may be expressed as a piecewise function across wavelengths. Further, the present disclosure contemplates development of correlation and correction functions to improve accuracy in extrapolated regions, which reduces the number of required wavelengths for calibration. Still further, embodiments described herein utilize a theoretical instrument correction function to account for the difference between the “true” dispersion curve, and that which has been fitted using a smaller subset of wavelengths. Moreover, further contemplated is the use of an optimized slit size or sizes for wavelength calibration, and/or calibrating at multiple slit positions.

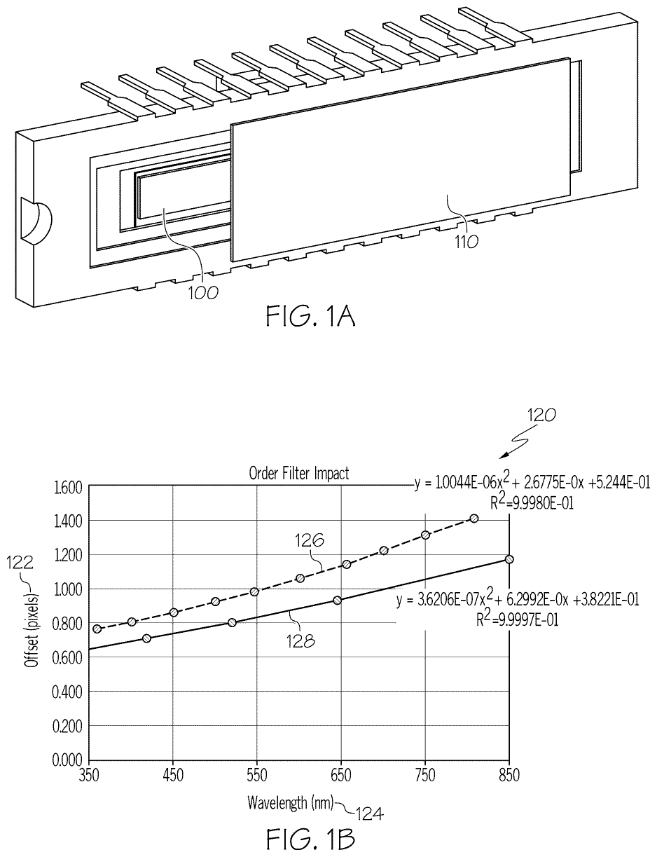

FIG. 1A depicts a perspective view of a photodiode array (PDA) sensor 100 being partially covered by an order filter 110, in accordance with one embodiment. FIG. 1B depicts a graph 120 plotting pixel offset 122 as a function of wavelength 124 for an exemplary PDA spectrometer, in accordance with one embodiment. As shown, a first curve 126 plotted and is analytical based on incident angle and refraction. A second curve 128 is plotted and is based on computational (Zemax) analysis. The functions for each curve are shown. As shown, the discontinuities in the spectrum introduce error. For example, when the order filter 110 partially covers the PDA sensor 100 as shown in FIG. 1A, as is the case with a typical order filter, light passing through the order filter 110 will refract slightly depending on its incident angle and the index of refraction of the order filter 110 as a function of wavelength. This refraction will cause an offset or shift in spectrum and can cause a discontinuity that introduces error. This offset is shown as a function of wavelength in the graph shown in FIG. 1B. Methods described herein will account for this type of error, as well as the other types described herein above, through improved calibration.

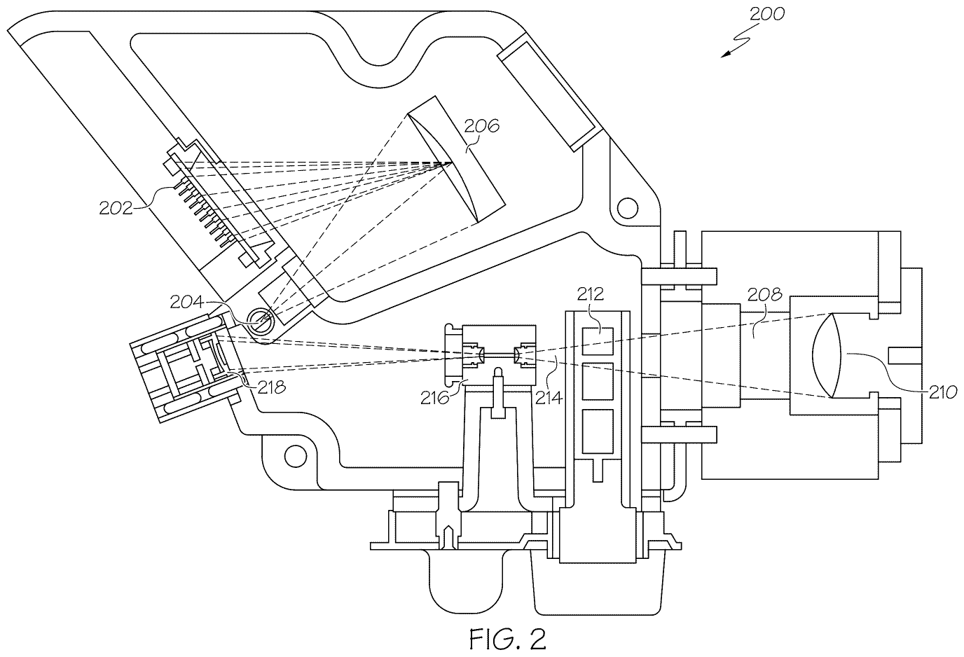

FIG. 2 depicts a side view of a PDA spectrometer 200, in accordance with one embodiment. The PDA spectrometer 200 includes various features, including a PDA sensor 202, a variable slit 204, and grating 206. The PDA spectrometer 200 includes a built in Deuterium lamp 208 including an M1 mirror 210. Light from the Deuterium lamp 208 passes through an optional cuvette or filter holder 212 and an Erbium Filter/Shutter 214. A flow cell 216 directs the light through another M2 mirror/mask 218 having the variable slit 204. From there, the light passes through the grating 206 and is thereby directed to the PDA sensor 202. While the PDA spectrometer 200 includes various features, the present methods and systems may be applied to any PDA spectrometer, and it should be understood that the PDA spectrometer 200 shown is exemplary and not limiting. Using the improved calibration processes described herein, using a Mercury Argon (Hg/Ar) calibration lamp, a piecewise function, and correlating this calibration curve with on-unit erbium calibration peaks, the PDA spectrometer 200 may be configured to reliability meet wavelength accuracy of +/−1 nm over its full spectral range.

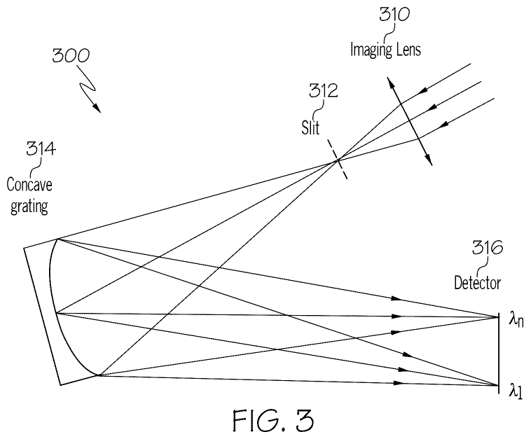

FIG. 3 depicts a schematic view of a PDA detector 300, in accordance with one embodiment. The PDA detector 300 is schematically broken down into its basic components of an imaging lens 310, a slit 312, concave grating 314, and a PDA detector 316. As shown, diffraction grating splits light into its component spectrum and distributes light spatially. The PDA detector 316 (or sensor) measures the signal intensity hitting each pixel, but does not inherently know the color of the light. Via alignment and calibration, it is possible to identify which pixels correspond to which wavelengths. Spectral peaks at known wavelengths are used to define a calibration curve that assigns wavelengths to pixels.

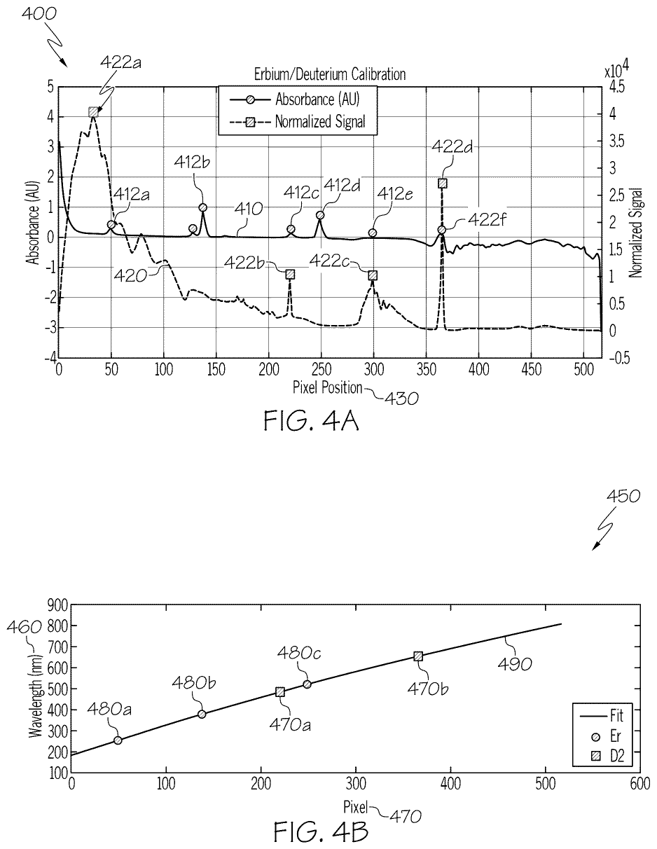

FIG. 4A depicts a graph 400 of the Deuterium lamp spectrum 420 and Erbium filter absorbance 410 vs. Pixel Position 430, in accordance with one embodiment. As shown, several Erbium peaks 412a, 412b, 412c, 412d, 412e, 412f, 412g occur at various positions between about 50 and 360 nm. Further, several Deuterium peaks 422a, 422b, 422c, 422d between about 30 and 360 nm.

FIG. 4B depicts a graph 450 plotting peak wavelength vs. pixel position for Deuterium and Erbium, in accordance with one embodiment. In particular, the graph 450 plots wavelength 460 vs pixel location 470. In particular, two Deuterium peak locations 470a, 470b are shown, and three Erbium peak locations 480a, 480b, 480c are shown. These five peaks (i.e. the three Erbium absorbance peaks 480a, 480b, 480c and the two Deuterium peaks 470a, 470b may define a calibration curve, as shown in FIG. 4B. A best fit line 490 is shown through each of the peak locations 470a, 470b, 480a, 480b, 480c.

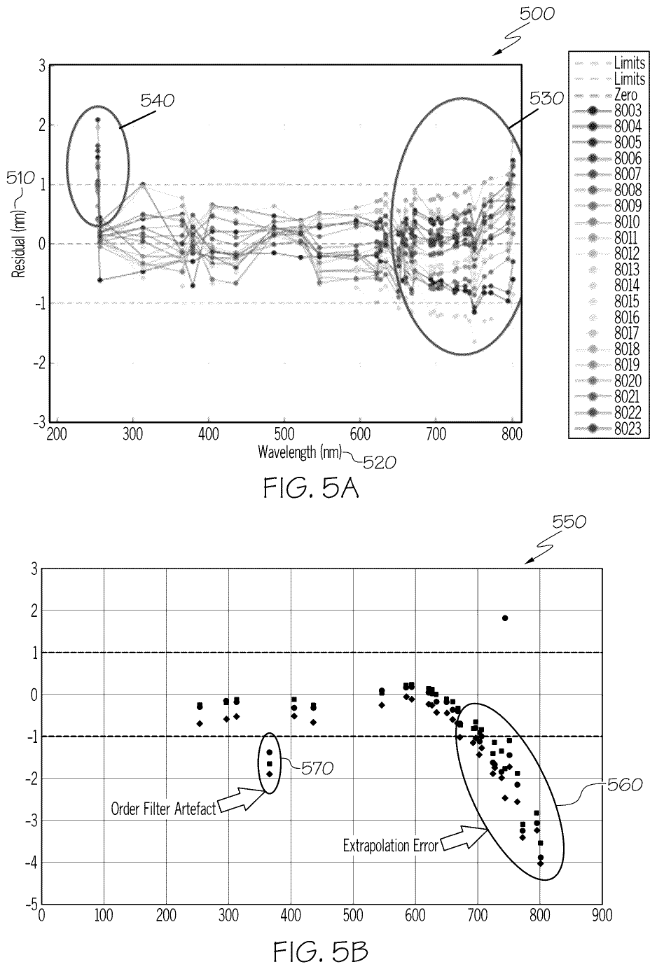

FIG. 5A depicts a graph 500 plotting residual 510 vs. wavelength 520 and showing extrapolation error 530 and UV error 540, in accordance with one embodiment. Similarly, FIG. 5B depicts another graph 550 plotting residual vs. wavelength and showing extrapolation error 560 and an order filter artefact 570, in accordance with one embodiment. The various errors 530, 540, 560, 570 shown in the example dispersion curves of FIGS. 5A-5B show that the Erbium peaks are inaccurate over its full spectral range. Moreover, the order filter introduces discontinuity in the spectrum, as shown by the order filter artefact 570.

As provided herein, a calibration lamp can be used at multiple exposure times or gain levels to detect a broader spectrum of peaks. For example, using a Mercury-Argon lamp provides atomic emission peaks from the mercury spanning 253 nm-546 nm. However, in addition to these large peaks, Mercury has additional lower-amplitude peaks, and there are also atomic emission lines from Argon present in the lamp. By taking spectra at multiple exposures, both high and low amplitude peaks from Mercury and Argon can be detected and used in calibration without concern for saturation. Alternatively, different gain settings can be used to acquire multiple spectra, or different gains/exposures can be used for different sensor pixels to get good spectral contrast for all peaks of interest. This provides additional peaks across a broader range of the spectrum that can enable a better curve fit for calibration and also minimizes extrapolation errors by having peaks closer to the extremes of the target range.

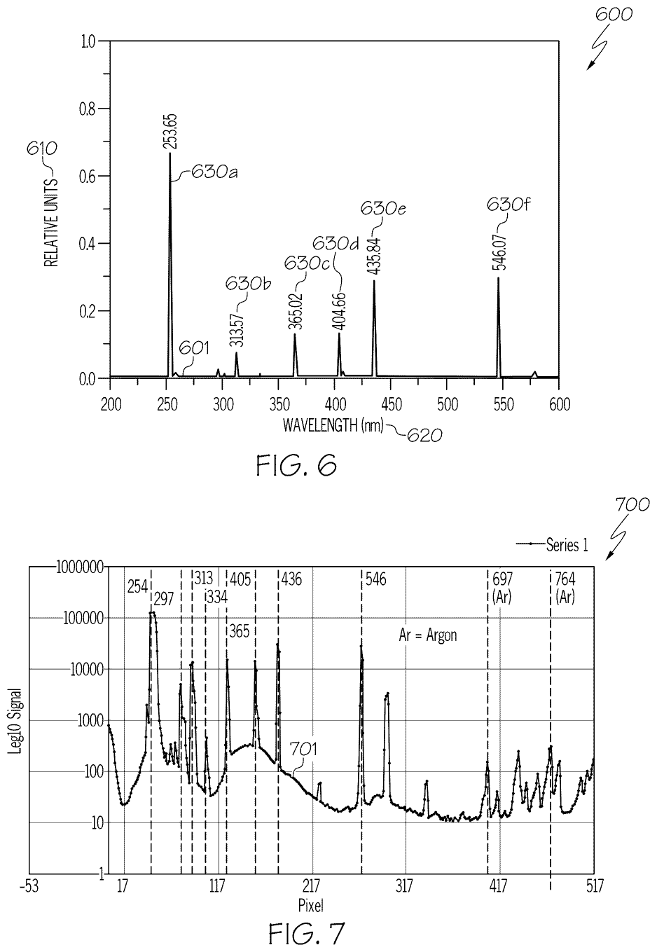

FIG. 6 depicts a graph 600 showing an example Mercury spectrum 601 graphing relative units 610 vs. wavelength 620 and showing main peaks from 253-546 nm, in accordance with one embodiment. As shown, the Mercury spectrum 601 includes several peaks 630a, 630b, 630c, 630d, 630e, 630f, including a first peak 630a at 253.65 nm, a second peak 630b at 312.57 nm, a third peak 630c at 365.02 nm, a fourth peak 630d at 404.66 nm, a fifth peak 630e at 435.84, and a sixth peak 630f at 546.07 nm. Mercury may be particularly beneficial in the present application for having sharp atomic emission lines which can be identified with high accuracy. However, the inventive concepts described herein are not limited to Mercury.

FIG. 7 depicts a graph 700 showing a high exposure semi-log plot of a Mercury-Argon spectrum 701 showing additional peaks that can be used in calibration, in accordance with one embodiment. By increasing exposure time or gain, it is possible to view additional peaks with the same lamp to get a better distribution across a greater spectral range. In particular, the dashed lines represent a subset of the peaks that are available for calibration, at the various wavelengths shown. Mercury lamps are advantageous for containing Argon, which have useful peaks from 697-800 nm. Additional argon peaks are shown at 697 and 764 nm.

A piecewise function can be used to correct for spectral discontinuities as a consequence of an order filter or any other element that may cause such a spectral feature. For example if the order filter edge is approximately located at 350 nm, peaks prior to 350 nm in the mercury spectrum can be used to fit one curve, and peaks beyond 350 nm can fit a second curve, to produce a piecewise calibration curve that corrects for the discontinuity due to the filter edge. The filter edge can also be defined by the sensor pixel location instead of by wavelength as it may be more invariant with calibration. Thus, it is possible to break the spectrum into two regions for example, pre and post filter. This may allow for fitting a piecewise function comprising two quadratics, for example.

FIG. 8 depicts a graph 800 showing an example piecewise calibration curve 801 fitting two quadratics to mercury peaks, in accordance with one embodiment. Specifically, a first quadratic (Ax²+B+C) is shown over a first portion 810 of the piecewise calibration curve 801 while a second quadratic (Dx²+Ex+F) is shown over a second portion 820 of the piecewise calibration curve 801.

Spectral lamps or certified standards can be readily used for factory calibration, but it is inconvenient to require these for re-calibration in the field, as each field engineer needs access to such a lamp/standard and may need to bring it to customer sites. In this case it is beneficial to be able to use an on-instrument calibration using, for example, on-unit optical filters such as erbium or holmium oxide, or spectral features from the instrument lamp, such as the 486 nm or 656 nm Balmer lines from a Deuterium lamp.

There are two challenges with the use of such calibration samples and/or filters. A first challenge is that the peaks may be precise but inaccurate relative to atomic emission lines. For example, a filter might have peak tolerances of +/−several nanometers. One solution to address this is to measure this inaccuracy using an initial calibration with a higher accuracy lamp or standard, such as Mercury-Argon lamp or NIST-certified standard, and then correct for the inaccuracy of the filter on the particular spectrometer being tested. For example, Erbium filter absorbance peaks can be measured against the calibration curve from a Mercury-Argon lamp at initial calibration, and the residuals can be measured to see how far off the measured erbium peak is from the calibration curve. The measured peak location (residual-corrected nominal wavelength) can then be used in subsequent verification or calibration using the erbium filter to correct for systematic bias or inaccuracy of the erbium peaks—effectively correlating a less accurate calibration standard to a more accurate one. Doing so can help a system better-recover the ideal calibration curve from the more accurate calibration. Note that while Erbium and Mercury-Argon lamps are referenced as an exemplary embodiment herein, other lamps or absorbance spectra could be used in a similar manner.

One example table of correcting wavelength using a residual value is shown below for an example peak:

| | | | | Residual |
|---|---|---|---|---|
| | Nominal | Corrected | Pixel | (Nominal − |
| PeakNumber | Wavelength | Wavelength | Location | Actual) |
| 1 | 256.459991 | 256.556915 | 47.991722 | −0.09691 |

For the above peak accuracy correction, ‘Nominal Wavelength’ is the expected wavelength value, while ‘Corrected Wavelength’ is the value that is found using a more accurate calibration curve. The corrected wavelength can be used in subsequent verification and calibration.

The second challenge with optical filters is that they may have fewer peaks distributed across the spectral range than a calibration lamp. This can cause inaccuracy or extrapolation error which is addressed and improved by the residual-correction described above but can also create a challenge if a piecewise fit is used in that there may not be sufficient peaks to fit the necessary calibration curve. For example, a quadratic fit requires a minimum of 3 points to define, but when calibrating with a piecewise function there might only be one or two peaks in a given region. In this situation, a correction can be performed using the relative shapes of the piecewise curves from the more accurate factory calibration. An example is provided herein below.

In the example, two piecewise quadratic fits from a high-accuracy calibration are given, for example using Mercury-Argon lamp, like that shown in FIG. 8:

$$A {x}^{2} + B x + C , and$$

$${Dx}^{2} + E x + F$$

Where the A/B/C coefficients are for the portion of the curve before an order filter, and D/E/F coefficients are the fit for the portion of the spectrum post-order filter, the difference between these two curves is given by:

$$( A {x}^{2} + B x + C ) - ( D {x}^{2} + E x + F ) = ( A - D ) {x}^{2} + ( B - E ) x + ( C - F ) = {δ}_{1} {x}^{2} + {δ}_{2} x + {δ}_{3}$$

Rewriting this equation:

$$A {x}^{2} + B x + C = ( D {x}^{2} + E x + F ) + ( {δ}_{1} {x}^{2} + {δ}_{2} x + {δ}_{3} )$$

The δ terms can be thought of as the correction between the two piecewise fits. If it is assumed that for small changes in alignment, this correction will not change significantly, then it is possible to use the correction to help recover the piecewise calibration curves even in the absence of sufficient points. A residual-corrected calibration where we are trying to get equivalent coefficients may be then denoted by primed coefficients:

$${A}^{′} {x}^{2} + {B}^{′} x + {C}^{′} , and$$

$${D}^{′} {x}^{2} + {E}^{′} x + {F}^{′}$$

It is then possible to fit one portion of the curve, and apply the delta terms to recover the other using the relationship:

$${A}^{′} {x}^{2} + {B}^{′} x + {C}^{′} = ( {D}^{′} {x}^{2} + {E}^{′} x + {F}^{′} ) + ( {δ}_{1} {x}^{2} + {δ}_{2} x + {δ}_{3} )$$

This provides for a correlated piecewise quadratic fit to both regions of the spectrum even with insufficient peaks, provided that changes from the initial calibration are small.

Furthermore, we can use calibration peaks to help adjust the calibration curve. For example, if one peak is in a region, the calibration curve may be forced to pass through that point by adding an additional offset term, δ₄.

$${A}^{′} {x}^{2} + {B}^{′} x + {C}^{′} = ( {D}^{′} {x}^{2} + {E}^{′} x + {F}^{′} ) + ( {δ}_{1} {x}^{2} + {δ}_{2} x + {δ}_{3} ) + {δ}_{4}$$

If x0 and λ0 are the pixel position and wavelength of the one calibration peak, it can be substituted into the calibration fit to solve for δ₄

$${δ}_{4} = {λ}_{0} - \{ {D}^{′} {x}_{0}^{2} + {E}^{′} {x}_{0} + {F}^{′} + ( {δ}_{1} {x}_{0}^{2} + {δ}_{2} {x}_{0} + {δ}_{3} ) \}$$

In the case where there are multiple calibration points, the curve can be offset or adjusted to minimize the error between the corrected fit and the available calibration peaks.

While quadratic fits were used as an example, other (e.g., higher order) fits could be similarly corrected. A similar methodology could be used but relative to a different calibration curve. In the piecewise quadratic example above, the case where we fit a single quadratic to all peaks can be expressed as:

$$G {x}^{2} + H x + I$$

The difference between this fit and the piecewise curves can be expressed as:

$$( A {x}^{2} + B x + C ) - ( G {x}^{2} + H x + I ) = ( A - G ) {x}^{2} + ( B - H ) x + ( C - I ) = {δ}_{1} {x}^{2} + {δ}_{2} x + {δ}_{3}$$

$$( D {x}^{2} + E x + F ) - ( G {x}^{2} + H x + I ) = ( D - G ) {x}^{2} + ( E - H ) x + ( F - I ) = {δ}_{4} {x}^{2} + {δ}_{5} x + {δ}_{6}$$

The fits may be similarly corrected relative to this curve using the δ terms and fit to available calibration peaks. This format has the benefit that the reference curve is a fit to all available calibration peaks, which may have less variation in some cases depending on the relative number of points in each piecewise region.

There may be situations where a calibration curve does a reasonable job of fitting the dispersion curve, but there are small systematic biases due to the shape of the dispersion curve relative to the fit, or due to spectral discontinuities as seen with an order filter, or any other factor that causes a consistent bias. Use of a higher-order fit to more calibration points might correct for this, but higher-order fits can be less stable, and can sometimes amplify noise by forcing a curve to pass through (or very close to) every calibration peak, and higher order curves also may not extrapolate well. In such cases it may be desirable to use a lower order fit that captures the overall trend, and then an empirical, analytical, or computational nominal error correction term to fix the systematic error. This combination has the benefit of improving the precision of a lower order fit, without adding the instability of a higher-order fit.

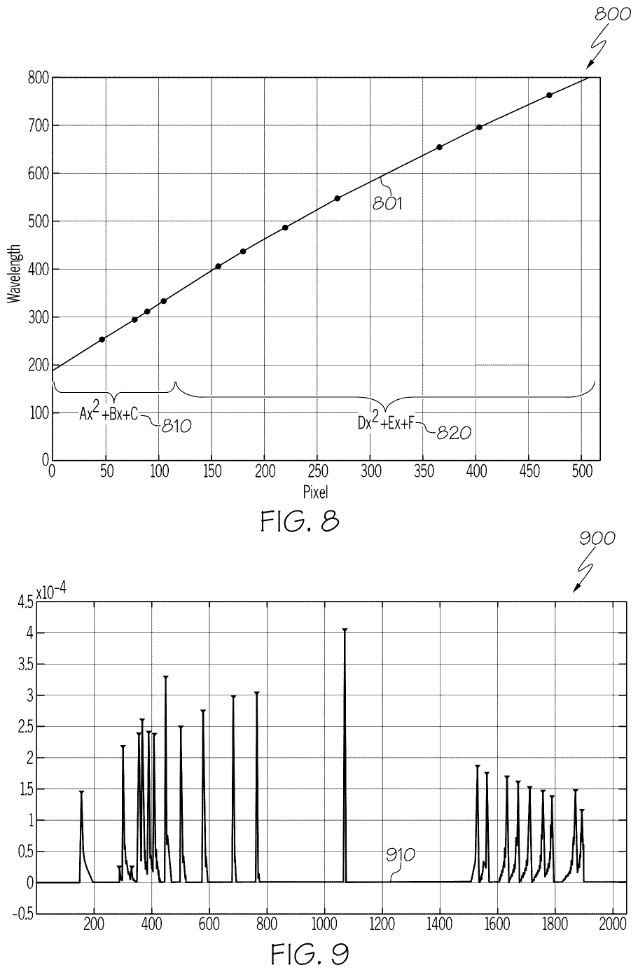

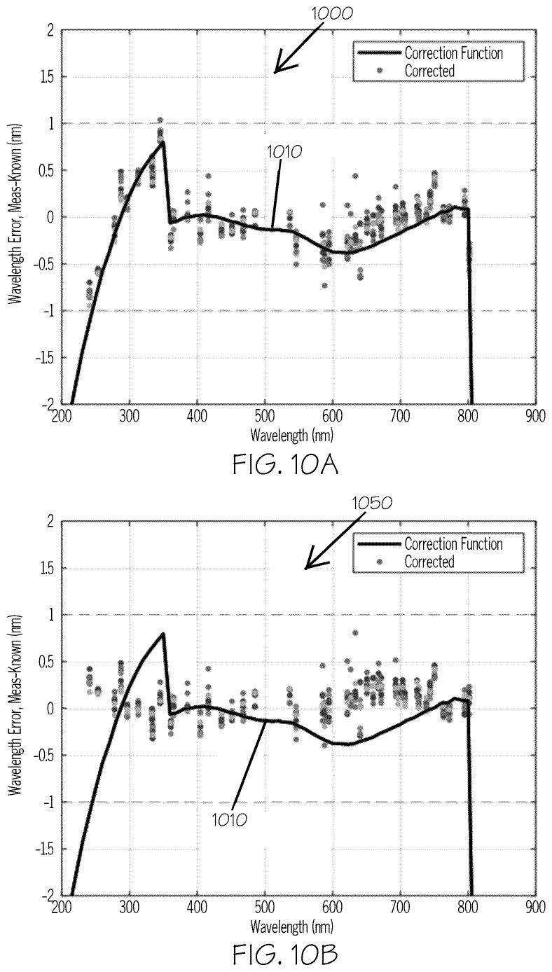

An example is shown in FIGS. 9, 10A and 10B using a Zemax optical model to correct a calibration curve. In particular, FIG. 9 depicts a graph 900 showing simulated Mercury-Argon peaks 910 for a Spectrometer in Zemax used to generate a computational calibration curve, in accordance with one embodiment. FIG. 10A depicts a graph 1000 showing pre-correction empirical data with a Zemax correction function 1010 overlaid showing good alignment, in accordance with one embodiment. FIG. 10B depicts a graph 1050 showing corrected data with the Zemax correction function 1010 showing improved error across the spectrum, in accordance with one embodiment.

In this case the calibration peaks are modeled in Zemax software and a typical polynomial calibration curve is fit. Peaks across a broad spectrum are found computationally and compared to the calibration curve to identify the theoretical error of the dispersion curve relative to the calibration curve. FIGS. 10A and 10B show this error as compared to experimental data showing good correlation, and then correcting the experimental data by subtracting the error curve to improve the error across the full spectrum. Note that while this works well with lower-order fits, the principal could also be applied to other more complex or higher order fits. This also has the added benefit of addressing complex spectral features without requiring a piecewise fit.

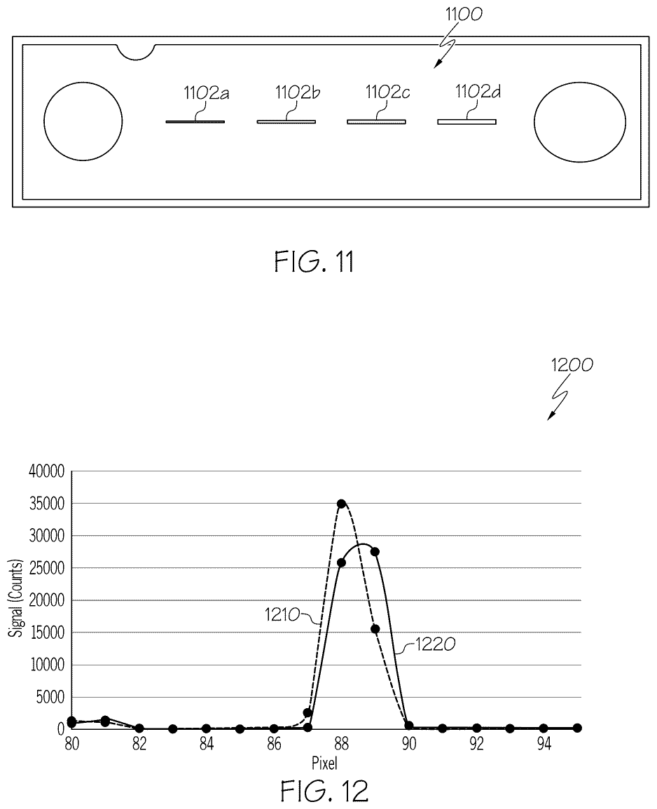

FIG. 11 depicts a front view of a variable slit mask 1100, such as the variable slit 204 shown in FIG. 2, in accordance with one embodiment. The variable slit mask 110 includes four slit widths 1102a, 1102b, 1102c, 1102d, in an exemplary embodiment, although any number of slit widths are contemplated. For example, the first slit width 1102a may include a width of 35 microns, the second slit width 1102b may include a slit width of 50 microns, the third slit width 1102c may include a slit width of 100 microns, and the fourth slit width 1102d may include a slit width of 150 microns. In cases where a spectrometer has a variable slit width, there may be slight shifts in the spectrum along with the different slit sizes. This may be compensated for by having calibration performed at each slit width (or a subset of the slit widths) and using either a slit-specific calibration, or possibly applying a single ‘average’ calibration based on the calibration curves at all slit widths. Using the above example slit widths of 35, 50, 100 and 150 microns, testing has shown that a calibration at 100 micron slit width of the third slit width 1102c produces improved consistency of wavelength accuracy data compared to other slit widths. An unintended byproduct of using sharp spectral lines is that the peaks may be sharper than the pixel size of the instrument—centration of the peak on or between pixels can affect our calculated peak position.

FIG. 12 depicts a graph 1200 showing a comparison of 313 nm Mercury spectral peaks when centered on or between two sensor pixels, in accordance with one embodiment. There may also be a circumstance whereby calibration is more accurate at a particular resolution. For example, if a peak is extremely sharp relative to the pixel size of the sensor, the pixel resolution may cause digital artefacts (e.g., shown as 570 in FIG. 5) in the peak-finding that may make it difficult to accurately refine the centration of that peak. As shown in FIG. 12, a first peak 1210 is well-centered on a specific pixel, while a second peak 1220 is centered between two pixels. Differences in the distribution of datapoints across these peaks may cause small shifts in the interpolated centration. In this case a calibration at lower resolution (larger slit width) with peaks that have more datapoints across them could result in more repeatable results. A similar effect could be attained by pixel binning or filtering of a more resolved spectrum. In the example, shown, the first peak 1210 may result from a 50 micron slit width while the second peak 1220 may result from a 100 micron slit width. As shown, the second peak 1220 may represent a broader peak than the first peak 1210. This broader peak may include a shape and centration which is better captured by the pixel size of the instrument.

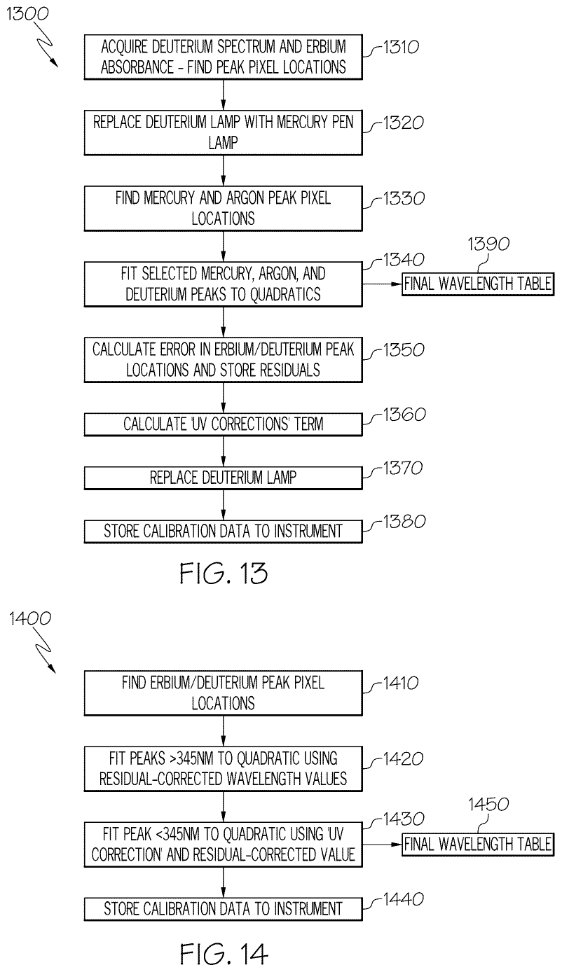

FIG. 13 depicts a method 1300 of photodiode array spectrometer calibration using a Mercury/Argon lamp in addition to a Deuterium lamp and Erbium filter, in accordance with one embodiment. The method 1300 is shown including a first step 1310 which includes acquiring a Deuterium spectrum and Erbium absorbance using a Deuterium lamp of a spectrometer. The step 1310 may further include finding Deuterium and Erbium peak pixel locations using the Deuterium lamp.

The method 1300 may include another step 1320 of replacing the Deuterium lamp with a Mercury Argon lamp in the spectrometer. For example, the Deuterium lamp may be a lamp located in the spectrometer, and this may be removed in order to be replaced temporarily by the Mercury Argon lamp for the purpose of factory calibration. The method 1300 may then include a step 1330 of finding Mercury and Argon peak pixel locations using the Mercury Argon lamp.

The method 1300 may then include a step 1340 of selecting one or more of each of the Mercury, Argon and Deuterium peak pixel locations and generating a calibration curve by fitting the selected one or more Mercury, Argon and Deuterium peak pixel locations to one or more functions of the calibration curve. The method 1300 may include a step 1390 of generating a wavelength table using the calibration curve.

The method 1300 may then include a step 1350 of calculating an error in the Deuterium and Erbium peak pixel locations, including determining a residual value representing how far off the Deuterium and Erbium peak pixel locations is from the calibration curve, and a step 1360 of calculating a residual corrected wavelength using the residual value of the Deuterium and Erbium peak pixel locations.

The method 1300 may include a step 1370 of replacing the Mercury Argon lamp with the Deuterium lamp in the spectrometer at any point using the Mercury Argon lamp to find the Mercury and Argon peak pixel locations. The method 1300 may then include a step 1380 of storing the calculated error, the residual value and/or the residual corrected wavelength into a calibration data storage system of the spectrometer.

FIG. 14 depicts a further method 1400 of calibrating the spectrometer using only a Deuterium lamp and Erbium filter using correction factors calculated during the calibration process of FIG. 13, in accordance with one embodiment. The method 1400 may include using the stored calculated error, the residual value and/or the residual corrected wavelength to perform a Erbium/Deuterium calibration for a spectrometer. The methodology described in the method 1400 may occur onsite after factory calibration, i.e. at a customer site.

In a first step 1410, the method 1400 includes using the Deuterium lamp of the spectrometer to acquire an onsite Deuterium spectrum and Erbium absorbance, including finding onsite Deuterium and Erbium peak pixel locations using the Deuterium lamp. The method 1400 then includes a step 1420 of fitting the onsite Deuterium and Erbium peak pixel locations to a first function of the calibration curve using the residual corrected values. This first function may span pixel locations of a post-filter region at greater than 345 nm, for example. The method 1400 then includes a step 1430 of fitting the onsite Deuterium and Erbium peak pixel locations to a second function of the calibration curve using the residual corrected values. The step 1430 includes using a UV correction term. Unlike the correcting for the accuracy of the peaks used in calibration corrected using the residual corrected values in step 1420, the UV correction term may account for differences in the shape of the dispersion curve or error curve between portions of the spectrum, for example, the region of the spectrum pre and post order filter. This second function may span pixel locations of a pre-filter region at less than 345 nm, for example. The method may include a step 1490 of generating a wavelength table using the calibration curve.

The method 1400 may further include a step 1440 of generating a wavelength table using the calibration curve and the fitted Deuterium and Erbium peak pixel locations using the residual corrected values and storing a calibration using the fitted Deuterium and Erbium peak pixel locations using the residual corrected values into the spectrometer.

The methodologies or techniques described herein may be used independently or in combination. Moreover, in various embodiments, the calibration can use peak maxima, peak minima, peak centroid, or some combination of these. Furthermore, the calibration can use spectral peaks, spectral minima, absorbance peaks, absorbance minima, mean values, median values, inflection points or some combination of these. Still further, calibration can be used for analog or digital data, discrete values, histograms, interpolated or fit functions.

While the description has included the exemplary embodiment using a Mercury Argon pen lamp, the calibration can use combinations of lamps, lasers, monochromators, LEDs, or absorbance samples such as cuvettes or filters. In some embodiments, this lamp may be manually exchanged in the place of a Deuterium lamp during factory calibration. However, in other embodiments, one or more calibration lamps may further be integrally provided in the spectrometer. Thus, the calibration capability can be automated and/or integrated onto the instrument, for example using integrated lamps or filters within the spectrometer. Multiple lamps or filters can be used. Moreover, spectral peaks and/or minima or absorbance peaks and/or minima can be generated using lamps, liquid or gas samples, optical filters (bandpass, notch), or any other method to produce a spectral feature at a known wavelength.

It is further contemplated, that the calibration described above may be performed in a controlled environment (temperature, atmosphere, pressure, light/vibration/acoustic isolation) to minimize variation. Calibration peaks and/or minima may be filtered for noise or to modify peak shape, for example to make them smoother, broader, or narrower, including via convolution or deconvolution.

Peak locations may be interpolated or located using any number of methods, including polynomial, spline, or gaussian fits, as well as first/second derivative methods. Calibration may use multiple diffraction orders or octaves to generate peaks across a broader range of the sensor. Furthermore, calibration may be performed with various reference samples, such as air, water, buffer solutions, acids, bases, organic solvents, or mixtures for various purposes.

While various examples have been shown and described, the description is intended to be exemplary, rather than limiting and it should be understood by those of ordinary skill in the art that various changes in form and detail may be made therein without departing from the scope of the invention as recited in the accompanying claims.

What is claimed is:

1. A method of photodiode array spectrometer calibration comprising:
acquiring a first spectrum using a first spectral source of a spectrometer;
finding spectral data points at pixel locations from the first spectrum;
replacing the first spectral source with a second spectral source in the spectrometer;
finding spectral data points at pixel locations using the second spectral source;
selecting one or more of the spectral data points;
generating a calibration curve by fitting the selected spectral data points to one or more functions of the calibration curve; and
using the selected spectral data points and the calibration curve to calibrate the spectrometer.

2. The method of claim 1, wherein the first spectral source is a Deuterium lamp and wherein the second spectral source is a Mercury Argon lamp, and wherein the first spectrum includes a Deuterium spectrum and an Erbium absorbance, and wherein the second spectrum includes Mercury and Argon peak pixel locations, and wherein the spectral data points are peak pixel locations, and wherein the using the selected one or more Mercury, Argon and Deuterium spectral data points and the calibration curve to calibrate the spectrometer further includes:
calculating an error in the Deuterium and Erbium peak pixel locations, including determining a residual value representing how far off the Deuterium and Erbium peak pixel locations are from the calibration curve;
calculating a residual corrected wavelength using the residual values of the Deuterium and Erbium peak pixel locations;
storing the calculated error, the residual value and/or the residual corrected wavelength into a calibration data storage system of the spectrometer.

3. The method of claim 1, wherein the one or more functions includes a first function for a first pre-filter region and a second function for a post-filter region, the method further comprising:
describing the calibration curve as a piecewise function using the first function for the pre-filter region of a pixel range and the second function for the second function for the post-filter region of the pixel range.

4. The method of claim 1, wherein the first spectral source is a Deuterium lamp and wherein the second spectral source is a Mercury Argon lamp, and wherein the first spectrum includes a Deuterium spectrum and an Erbium absorbance, and wherein the second spectrum includes Mercury and Argon peak pixel locations, the method further comprising verifying the spectrometer calibration using the stored calculated error, the residual value and/or the residual corrected wavelength.

5. The method of claim 1, wherein the first spectral source is a Deuterium lamp and wherein the second spectral source is a Mercury Argon lamp, and wherein the first spectrum includes a Deuterium spectrum and an Erbium absorbance, and wherein the second spectrum includes Mercury and Argon peak pixel locations, the method further comprising:
using a plurality of gain and/or exposure settings to acquire peaks at different amplitudes over a range of the spectrums; and
generating the calibration curve by fitting the acquired peaks at different amplitudes over the range of spectrums to the one or more functions of the calibration curve.

6. The method of claim 1, further comprising at least one of:
filtering data points of at least one of the first spectrum and the second spectrum for noise or to modify peak shape; and
replacing the second spectral source with the first spectral source in the spectrometer after the finding the peak pixel locations of the second spectral source.

7. The method of claim 1, wherein the step of finding peak pixel locations using the second spectral source is conducted during manufacturing the spectrometer.

8. The method of claim 1, wherein the first spectral source is a Deuterium lamp and wherein the second spectral source is a Mercury Argon lamp, and wherein the first spectrum includes a Deuterium spectrum and an Erbium absorbance, and wherein the second spectrum includes Mercury and Argon peak pixel locations, and wherein the steps of acquiring a Deuterium spectrum and Erbium absorbance using a Deuterium lamp of a spectrometer and finding Mercury and Argon peak pixel locations using the Mercury Argon lamp are each conducted in a controlled environment to minimize variation.

9. A method of photodiode array spectrometer calibration comprising:
acquiring one or more spectrums using one or more spectral sources;
generating a calibration curve for a spectrometer expressing wavelength over a pixel range of spectral data points for the one or more acquired spectrums;
describing the calibration curve as a piecewise function using at least a first function over a first portion of the pixel range and a second function over a second portion of the pixel range; and
using the calibration curve for calibration of a spectrometer.

10. The method of claim 9, wherein at least one of:
the first function is a first quadratic and the second function is a second quadratic;
the first function spans across a pre-filter region of the pixel range and wherein the second function spans across a post-filter region of the pixel range; and
the acquiring one or more spectrums using one or more spectral sources includes acquiring a first spectrum using a Deuterium lamp of the spectrometer and further includes acquiring a second spectrum from a Mercury Argon lamp.

11. The method of claim 9, wherein the spectral data points include at least one of:
spectral peaks, spectral minima, absorbance peaks, absorbance minima, mean values, median values, inflection points and/or combinations thereof, and
peak maxima, peak minima, peak centroid, and/or combinations thereof.

12. The method of claim 9, wherein the one or more spectral sources includes at least one lamp, laser, monochromator, LED, absorbance samples, and/or combinations thereof.

13. The method of claim 9, wherein at least one of:
at least one of the first function and the second function are each selected from the group consisting of a polynomial function, a rational function, and a grating equation; and
the at least one function includes three or more functions spanning across three or portion portions of the pixel range.

14. The method of claim 9, further comprising correcting for discontinuity due to a filter edge with the piecewise function.

15. A method of photodiode array spectrometer calibration comprising:
acquiring one or more spectrums using one or more spectral sources;
generating a calibration curve for a spectrometer by fitting a range of spectral data points to one or more functions of the calibration curve;
generating a dispersion curve for the spectrometer;
calculating an error in the generated calibration curve relative to the dispersion curve; and
storing the calculated error into a calibration data storage system of the spectrometer.

16. The method of claim 15, wherein the calculating the error further comprises at least one of:
determining a residual value representing how far off one or more of the range of spectral data points are from the generated calibration curve;
analytically measuring the error across the one or more spectrums relative to the one or more functions;
computationally calculating the error relative to the fit of the calibration curve; and
subtracting the calculated error from acquired data during a validation process to improve accuracy of the acquired data.

17. The method of claim 15, wherein the first spectral source is a Deuterium lamp of the spectrometer, the method further including using the second spectral source to acquire the second spectrum, wherein the second spectral source is a Mercury Argon lamp.

18. The method of claim 15, wherein the spectral data points include at least one of:
a spectral peak, a spectral minima, an absorbance peak, an absorbance minima, a mean value, a median value, an inflection point and/or combinations thereof, and
a peak maxima, a peak minima, a peak centroid, and/or combinations thereof.

19. The method of claim 15, wherein the one or more spectral sources includes at least one lamp, laser, monochromator, LED, absorbance samples, and/or combinations thereof.

20. The method of claim 16, further comprising:
calculating a residual corrected wavelength using the residual value for a first spectral data point.

21. The method of claim 15, wherein spectral data points are interpolated using a method selected from the group consisting of a polynomial regression, a spline interpolation, a gaussian fit, and a first or second derivative method.

22. A method of photodiode array spectrometer calibration comprising:
acquiring a first spectrum from a first spectral source of a spectrometer using a first slit position;
performing a first calibration of the spectrometer using the first spectrum;
acquiring a second spectrum from the first spectral source using a second slit position;
performing a second calibration of the spectrometer using the second spectrum.

23. The method of claim 22, further comprising at least one of:
determining whether the first calibration or the second calibration is more accurate and calibrating the spectrometer using the more accurate calibration;
generating an average calibration using each of the first calibration and the second calibration and calibrating the spectrometer using the average calibration; and
acquiring a spectrum from the first spectral source of a spectrometer using each slit position of a variable slit device and performing a calibration of the spectrometer using the spectrum a from each slit position.

24. The method of claim 22, further comprising acquiring a spectrum from the first spectral source of a spectrometer using each slit position of a variable slit device and performing a calibration of the spectrometer using the spectrum a from each slit position, and at least one of:
determining which slit position of the variable slit device includes the most accurate calibration and calibrating the spectrometer using the most accurate slit position; and
generating an average calibration using each of calibrations from each slit position and calibrating the spectrometer using the average calibration.
